(19) United States
(12) Patent Application Publication
(10) Pub. No.: US 2022/0260385 A1
(43) Pub. Date: Aug. 18, 2022

(54) SYSTEM AND METHOD FOR PRIORITIZING NAVIGATION DESTINATIONS OF VEHICLES

(71) Applicant: 4.screen GmbH, Müchen (DE)

(72) Inventors: Fabian Beste, München (DE); Simon Hecker, Zürich (CH); Christoph Mahlert, München (DE)

(21) Appl. No.: 17/674,636

(22) Filed: Feb. 17, 2022

(30) Foreign Application Priority Data
Feb. 18, 2021 (DE) 10 2021 103 806.5

(51) Int. Cl. G01C 21/36; G01C 21/34; G06V 20/58

(52) U.S. Cl. CPC G01C 21/3617; G06V 20/58; G01C 21/3461; G01C 21/3484

(57) ABSTRACT

A system for prioritizing navigation destinations of vehicles. The system includes a communication unit adapted to receive at least one navigation request from a vehicle computing unit, the at least one navigation request being assigned at least one piece of vehicle information and/or piece of driver information, an offer server on which a plurality of offers are stored. A plurality of offer parameters comprise an offer location associated with each offer.

The present invention relates to a system for prioritizing navigation destinations of vehicles according to claim 1 and a corresponding method according to claim 11.

Navigation systems are regularly used in modern vehicles, allowing the driver of the vehicle to navigate to a navigation destination.

Typically, a driver (or a vehicle occupant) may search for “points of interest” in a navigation system of the vehicle. For example, the driver may search for “restaurants” and receive a list of restaurants, with such a list sorted in descending order by distance from the restaurants. The same applies to gas stations, supermarkets, doctors' offices or retail stores, or any other type of an offer location.

This type of suggestion of navigation destinations, taking into account only a distance of the destinations from a corresponding vehicle, is considered to be in need of improvement and inefficient. In particular, because merely considering a distance of a destination regularly leads to an expectation of an offer at the closest destination (or at a nearby destination) not meeting a driver's needs or expectations. As a consequence, a driver has to search for alternative offers on his own and has to take detours to an alternative (possibly not even suggested) destination in order to find an offer at the alternative destination that meets his expectations or needs. These detours result in disproportionate fuel and energy consumption on the part of the vehicle.

On the other hand, it may happen—especially in conurbations with many stores, restaurants, etc.—that not all relevant destinations or destination suggestions can be displayed at once (or on one page) if the display size of a navigation system is limited. Therefore, there is also a need to identify a specific selection of offers and thus to display offers to a driver that are as appropriate as possible. Thus, the interaction between the user and the navigation system can be made more efficient. Input errors, which frequently occur in connection with touchscreens, for example, are avoided.

It is therefore an object of the present invention to provide a system as well as a corresponding method that enables navigation destinations for vehicles to be suggested efficiently and in accordance with the situation.

According to the invention, this object is solved by a method according to claim 1, a computer-readable storage medium according to claim 11, and a computer program code according to claim 16.

In particular, the object is solved by a system for prioritizing navigation destinations of vehicles, the system comprising:
a communication unit adapted to receive at least one navigation request from at least one vehicle computing unit, the at least one navigation request being associated with at least one piece of vehicle information and/or piece of driver information,
an offer server on which a plurality of offers are stored, wherein a plurality of offer parameters, comprising an offer location, are associated with each offer;
a server computing unit adapted to
a) determining a selection of offers based on the navigation request;
b) assign a priority value to the offers of the selection of offers, considering the offer parameters and at least one piece of vehicle information and/or piece of driver information of the navigation request; and
c) sending the assigned priority values to the at least one vehicle computing unit in response to the navigation request to cause the at least one vehicle computing unit to prioritize at least one navigation destination using the priority value.

An essential aspect of the invention is to suggest or initialize destinations by means of a vehicle navigation system, considering vehicle-specific and/or driver-specific data. On the one hand, these navigation destinations can be prioritized according to the interests, preferences or tastes of a driver or passenger, and on the other hand, vehicle-specific criteria can also be considered when prioritizing the navigation destinations. At the same time, offer providers (e.g., gas station operators, restaurant operators, supermarket operators, etc.) are given the opportunity to provide corresponding offer parameters for prioritizing navigation requests. For example, a restaurant operator can provide an offer parameter that the restaurant has at least one (currently free) charging station. If a driver of a vehicle with a low state of charge is looking for a restaurant, for example, a navigation destination for the restaurant with the charging station is prioritized over restaurants without a charging station. Such suggestions for navigation destinations adapted to the specific situation can efficiently minimize a route for the driver to save fuel or energy. At the same time, providers can also store or specify offer parameters for corresponding target groups on a corresponding web-based platform of the offer server in order to prioritize the suggested navigation destinations of these target groups accordingly. In this way, providers of luxury goods or luxury services can, for example, define offer parameters that appeal to drivers of luxury cars. Providers of child-friendly restaurants (or other offers) can, for example, store offer parameters that appeal to drivers of family vehicles. For this purpose, for example, offer parameters can be stored that are directed at specific vehicle information and indicate, for example, that the vehicle (model) should be a (compact) bus such as a minivan, or that there are at least 3 or 4 occupants in the vehicle, which is or can be determined via corresponding force sensors in the vehicle seats.

A priority value is a numerical value, for example, that results from a match between the offer (location) and the (navigation) request, considering driver information and/or vehicle information and offer parameters. A high priority value for a navigation destination means that the offer and driver-side demand (corresponding to the request) largely match here. Alternatively, a priority value in the sense of the invention may be defined in such a way that a high or low priority value leads to the result being displayed or delivered in such a way that the selection of a result with a high priority value is more likely than the selection of a result with a lower priority value.

In the context of this application, a driver is understood to be an actual driver but also, for example, a passenger or generally a vehicle occupant. This applies accordingly to drivers or vehicle occupants of autonomously driving vehicles.

For example, a prioritized navigation destination (i.e., an offer or destination with the highest priority value) can be displayed/suggested to the driver as the first (top) destination of a list or as the only destination. Alternatively, navigation of the vehicle to the prioritized navigation destination may be directly initialized without requiring any interaction of the driver and/or other occupants of the vehicle.

In one embodiment, the communication unit is adapted to receive result information from the at least one vehicle computing unit, wherein the result information comprises, in particular, information indicating whether a corresponding vehicle has approached an offer location of a corresponding offer, and/or indicating corresponding stay times at the offer location, and/or indicating whether a transaction has taken place, in particular at the offer location.

By a corresponding positive or negative result, the driver information and/or vehicle information can be updated accordingly. A positive result can be a transaction at the offer location (for example, a purchase of goods or services or similar). A negative result can be, for example, that the prioritized navigation destination or the corresponding offer location was not approached at all or bypassed. A negative result can also be that the navigation destination was displayed but not selected.

Subsequent navigation requests from this driver (or another driver) can be optimized for the driver, considering this (piece of) result information. For this purpose, the computing unit may comprise a self-learning system, such as a neural network. The self-learning system can generate corresponding driver profiles based on a plurality of driver information and vehicle information as well as result information, and thus further optimize future navigation destinations with respect to future navigation requests for drivers according to the respective driver profile. On the one hand, the selection of offers or the assignment of a priority value can be improved in this way. Thus, detours can be avoided and a fuel consumption or an energy consumption of a vehicle can be reduced. In addition, it is possible to create feedback for providers of the offers—in this way, a provider can optimize the offer parameters. Overall, this will further improve the overall performance of the system and thus improve the suggestions for navigation destinations.

In one embodiment, the system comprises vehicles each having at least one vehicle computing unit.

This enables the vehicle computing unit of a vehicle to retrieve data and transmit it to the communication unit. Furthermore, sensor signals can be acquired by means of a vehicle computing unit and corresponding vehicle sensors and thus further driver information and/or vehicle information can be obtained, which can be transmitted to the communication unit if necessary. Overall, the suggestions for navigation destinations are thus significantly improved—with regard to driver interests or needs or vehicle-specific necessities such as refueling, charging, washing, tire changes, etc.

In one embodiment, the at least one vehicle computing unit is adapted to acquire and/or evaluate sensor signals from vehicle sensors and to determine the result information based on the sensor signals, as well as to transmit the result information to the communication unit.

The sensor signals from vehicle sensors are easily and inexpensively accessible, since they are usually acquired and used in the vehicles anyway. This means that the system can be operated with comparatively little effort. This further improves the overall performance of the system and thus optimizes the suggestions for navigation destinations.

In one embodiment, the vehicle comprises vehicle sensors, for example, position sensors, filling level sensors, force sensors, and the at least one vehicle computing unit is adapted to transmit the vehicle information and/or the driver information at least partially using sensor signals from at least one of the vehicle sensors.

Most vehicles already include such sensors ex factory—position sensors (for example GPS sensors) to determine a vehicle position, filling level sensors to determine a load and/or tank level force sensors in the seats to determine a number of vehicle occupants, or at least one interior camera to determine a number of vehicle occupants but also, for example, to determine one or more further parameters such as emotions, gender or age of the vehicle occupant(s). Therefore, the consideration of the corresponding sensor signals of the vehicle sensors can be used cost-effectively and with little additional effort to prioritize navigation destinations according to the situation. For example, a suggestion for a navigation destination can thus be optimized depending on a number of vehicle occupants and/or a load or tank level. Alternatively or additionally, it is possible for sensor signals to be used as a triggering event for sending a navigation request—for example, when the tank level is low or the battery is almost empty. In this way, detours can be avoided, thus saving fuel or energy.

In one embodiment, the server computing unit and/or the at least one vehicle computing unit is/are adapted to filter the plurality of offers according to the respective priority value such that only offers and/or priority values above a priority value limit are considered when sending to the vehicle computing unit.

In this way, the driver can be shown only the most relevant offers—i.e., the navigation destinations with the highest priority value—for example, only one, or two, or only the first three. Overall, this improves the handling of the system. This is particularly advantageous in the case of limited display sizes in the vehicle, as a selection of navigation destinations can thus be limited to the most essential destinations (with the highest priority value). This makes it easier for a driver to select a destination.

In one embodiment, the at least one vehicle computing unit is adapted to transmit a piece of offer verification information to a user terminal such that a transaction at the offer location, in particular at a checkout at the offer location, can be verified outside the vehicle by a vendor.

In this way, data or information can be generated that measures the success of a selection of offers and/or a corresponding prioritization of navigation destinations. In this way, the overall performance of the system can be optimized, since the generated data or information can be considered in a subsequent selection of offers and/or a corresponding prioritization of navigation destinations. For example, if a driver never drives to a specific navigation destination or never makes a purchase or other transaction there, the driver's interest in that offer or navigation destination is classified as low and stored in the driver information associated with the driver. In subsequent navigation requests from this driver, the corresponding destination can then either not be considered at all or be considered with a lower priority value. The piece of offer verification information can also improve customer loyalty or customer relations between the provider and the driver. For example, it is conceivable that an offer parameter includes discounted charging/fueling for the driver and/or a free coffee for a corresponding purchase and points this out to the driver. Via a corresponding app on a user terminal, the driver can present the piece of offer verification information (for example, a QR code) at the offer location (for example, at a checkout) to receive the corresponding discount. This makes the system particularly user- and provider-friendly. In an alternative embodiment, the driver can (actively) search (send a corresponding navigation request) for such an offer parameter, i.e., for example, for an offer parameter that points the driver to a subsidized (discounted) charging station. For this purpose, the driver can also add further driver information and/or vehicle information to the navigation request. For example, the driver can thus search for subsidized charging stations along (or near) his route.

In one embodiment, the vehicle computing unit is adapted to cause a vehicle interaction device to display at least one prioritized navigation destination, and preferably a piece of offer information, in particular such that the at least one prioritized navigation destination is selectable by means of the vehicle interaction device to initialize navigation to a prioritized navigation destination.

In this way, the selection of the navigation destination is communicated and displayed to the driver or vehicle occupant. In case of interest or need, the driver or vehicle occupant can select the navigation destination and thus initialize a navigation with the vehicle to the navigation destination. Further, the provider of the offer is given the opportunity to advertise the offer by means of a piece of offer information. For example, the piece of offer information for the navigation destination may include useful information (such as “charging station available”) or promotional offers such as discount promotions. Overall, this way, the selection of navigation destinations is made comparatively informative and improved. On the other hand, in this way, the prioritized navigation destination can be tailored to vehicle-specific interests and/or driver-specific interests of the driver or vehicle occupants—for example, a charging station or a gas station can be prioritized for drivers of a luxury class vehicle if a luxury café is in the vicinity of the charging station or gas station. Ultimately, the driver decides on an (existing) available charging station or filling station, possibly sponsored (by a corresponding provider), that is personally relevant to him or her, in the vicinity of options or providers that are relevant to him or her (such as stores, cafés or the like).

In one embodiment, the at least one vehicle computing unit is adapted to acquire and/or evaluate sensor signals from vehicle sensors, for example acoustic or optical sensors and/or fatigue sensors and/or filling level sensors, and to send at least one navigation request to the communication unit based on the sensor signals (and a corresponding interpretation of the sensor signals).

In this way, the driver (automatically) receives helpful and, if necessary, vehicle-specific or driver-specific navigation instructions. For example, if the vehicle's tank/battery is empty, the driver is navigated to a gas station/charging station of a provider or receives a corresponding suggestion for this. Accordingly, if driver fatigue is detected, a suggestion for navigation to a café or a rest area of a provider can be displayed or initialized. This can be particularly helpful for drivers in unfamiliar regions. In this way, a driving route can be optimized, thereby saving fuel or electrical energy. Likewise, it is possible to use the acoustic sensors to recognize, for example, stimulus words from a conversation or voice input or from the radio in the passenger compartment and to send corresponding navigation requests and suggest navigation destinations or initialize the navigation accordingly. Overall, this makes the use of the system for prioritizing of navigation destinations particularly dynamic and user-friendly.

In one embodiment, the vehicle computing unit is adapted to detect passenger fatigue and/or to detect a tank state or charge state and/or to detect an object in the surrounding of the vehicle and/or to detect a stimulus word in the passenger compartment, based on sensor signals from at least one of the vehicle sensors.

This adapts the prioritization of navigation destinations to the needs of the driver in particular. Overall, this results in comfortable navigation.

In particular, the object according to the invention is also solved by a method for prioritizing navigation destinations of vehicles, the method comprising the following steps:
receiving at least one navigation request from at least one vehicle computing unit of a vehicle, wherein at least one piece of vehicle information and/or piece of driver information is assigned to the at least one navigation request, by means of a communication unit;
providing a plurality of offers on an offer server, wherein a plurality of offer parameters, comprising an offer location, are associated with each offer;
determining a selection of offers based on the at least one navigation request;
assigning priority values to the offers of the selection of offers, considering the offer parameters and at least one piece of vehicle information and/or piece of driver information of the navigation request;
sending the assigned priority values in response to the navigation request to the at least one vehicle computing unit;
prioritizing a navigation destination using the priority values.

This results in the same benefits as those already described in connection with the system for prioritizing navigation destinations of vehicles.

In particular, the method can be implemented using the system described. Therefore, it should be noted that the features and advantages described in the context of the system according to the invention also apply to the method for prioritizing navigation destinations of vehicles according to the invention. Features of the system, in particular those relating to the acquisition of sensor signals or sending/receiving of navigation requests or information by means of the vehicle computing unit or the communication unit or computing unit or the offer server, are applicable to the method according to the invention. Likewise, features of the method according to the invention are transferable to the system according to the invention by adapting the corresponding device in such a way that it is suitable for carrying out the corresponding method features.

In one embodiment, the method comprises a step for receiving result information from the at least one vehicle computing unit with the communication unit, wherein the result information in particular comprises information indicating whether a corresponding vehicle has approached an offer location of a corresponding offer, and/or indicating corresponding stay times at the offer location, and/or indicating whether a transaction has been made at the offer destination.

In one embodiment, the at least one navigation request is sent in response to a passenger fatigue, detected by a fatigue sensor, and/or an acoustic signal or signal sequence, detected by an acoustic sensor, in particular a stimulus words in the passenger compartment.

In one embodiment, the at least one navigation request is sent in response to a detection of an object by an optical sensor in the vehicle surrounding.

In one embodiment, the at least one navigation request is sent in response to a low battery charge state and/or low tank filling state detected by a filling level sensor.

In particular, the object according to the invention is also by a computer-readable (storage) medium comprising instructions that, when executed by at least one computing unit, cause the computing unit to implement a method as described above.

This also results in the same advantages as already described in connection with the method and/or with the computer-readable storage medium and/or with the computer program code.

Further advantageous embodiments result from the subclaims.

In the following, the invention is also described with regard to further features and advantages on the basis of embodiments, which are explained in more detail based on figures.

Here shows:

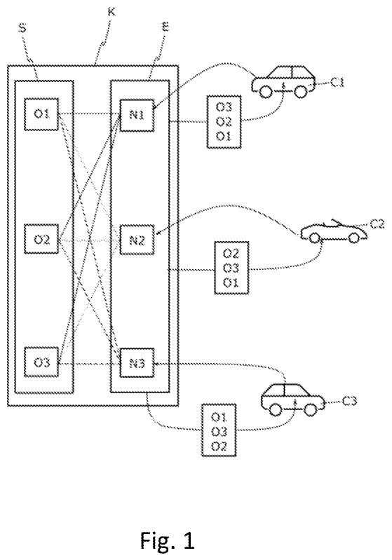

FIG. 1 a schematic embodiment of a sequence of a system for prioritizing navigation destinations of vehicles;

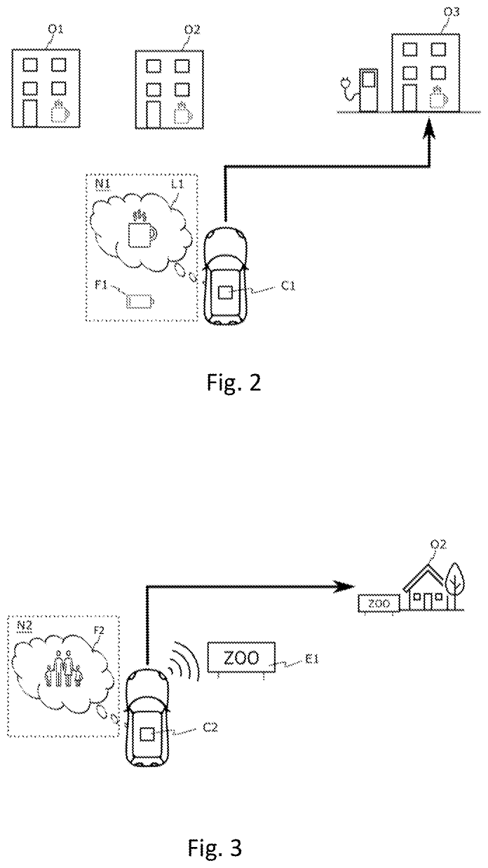

FIG. 2 a schematic embodiment for prioritizing a navigation destination based on a piece of driver information considering vehicle information;

FIG. 3 a schematic embodiment for prioritizing a navigation destination based on object recognition of an object in the vehicle surrounding, considering vehicle parameters;

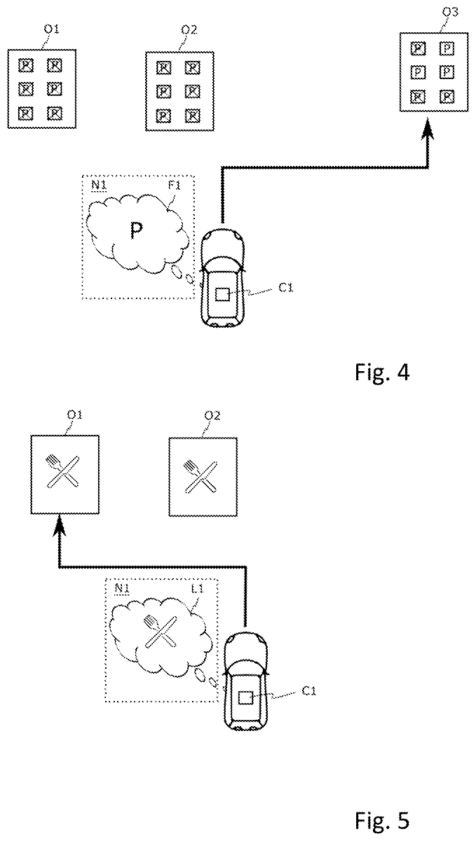

FIG. 4 a schematic embodiment for prioritizing a navigation destination based on a piece of vehicle information;

FIG. 5 a schematic embodiment for prioritizing a navigation destination based on a piece of driver information.

In the following description, the same reference signs are used for parts that are identical and have the same effect.

FIG. 1 schematically shows an embodiment of a sequence of a system for prioritizing navigation destinations of vehicles.

In the example shown, three vehicles are depicted, each with a vehicle computing unit C1, C2, C3. The vehicle computing units C1, C2, C3 each send a navigation request N1, N2, N3 to a communication unit E, with at least one piece of vehicle information and/or one piece of driver information being assigned to the respective navigation request N1, N2, N3.

The vehicle information includes vehicle-specific or vehicle-relevant information. This vehicle information can include, for example, sensor-based values from vehicle sensors relating to a position of the vehicle, a tank or charge state of the vehicle, a (current) number of vehicle occupants, a driving time duration indicating how long the vehicle has been on the road since the last longer stop, or other information from a vehicle data memory, such as a piece of vehicle model information (for example, model, manufacturer, year of manufacture), the most recent service date of the vehicle, etc.

The driver information comprises person-specific data of the driver or the vehicle occupant. On the one hand, this can include information about the driver's age, gender, interests or tastes, and on the other hand, it can include the driver's current needs—i.e. needs at the time of the navigation request. A momentary need can be, for example, hunger or thirst of the driver or a vehicle occupant.

According to the embodiment, three offers O1, O2, O3 of providers are stored on an offer server S. Of course, the number three serves merely as an exemplary simplified example for a plurality of offers. These offers O1, O2, O3 can be deposited on the offer server S by corresponding providers via a web-based platform, with a plurality of offer parameters comprising an offer location being assigned to each offer.

Providers can be, for example, gas station operators, restaurant operators, supermarket operators, parking garage providers, retailers, charging station providers, gas station operators, ATMs, doctor's offices, retail hotel businesses, or the like.

The offer parameters may generally comprise, for example, information about goods or services of the providers at the offer location. The offer parameters may, for example, include information that the goods or services at the offer location are tailored to driver target groups or vehicle target groups—i.e. that they (at least partially) match the vehicle information transmitted by the vehicle computing unit C1, C2, C3.

A server computing unit K is adapted to determine the selection of the offers O1, O2, O3 based on the navigation requests N1, N2, N3; and to assign a priority value to the offers O1, O2, O3 of the selection of offers considering the offer parameters and at least one piece of vehicle information and/or driver information of the navigation request; and sending the assigned priority values to the vehicle computing units C1, C3, C3 in response to the navigation request N1, N2, N3 to cause the at least one vehicle computing unit C1, C2, C3 to prioritize at least one navigation destination using the priority value.

In one embodiment, the server computing unit K, the communication unit E and the offer server S are set up on a common server unit. Alternatively, the server computing unit K, the communication unit E and the offer server S can be set up on different (distributed) server units.

When an offer or at least one corresponding (prioritized) navigation destination is displayed in the vehicle, several scenarios arise:

1) The offer was selected and navigation to the destination was started.
a) The vehicle occupant has arrived at the destination,
b) The vehicle occupant has stopped navigation before reaching the destination.
c) The vehicle occupant has replaced the prioritized navigation destination with another navigation destination (with lower priority).

2) The offer or prioritized navigation destination was ignored.
a) No navigation has been started.
b) Another navigation destination has been selected.

Each of the above scenarios is detected by the vehicle computing unit and transmitted to the communication unit E as piece of result information. Such a piece of result information thereby comprises a set of context information of the vehicle and/or the vehicle occupant, such as:
All the destinations that were available for the vehicle occupant to choose from in total.
The selection of the (actual) navigation destination, even if it was not the prioritized navigation destination.
Location and time of interaction of the vehicle occupant or the vehicle computing unit C1, C2, C3 with the communication unit E.
Vehicle information from vehicle sensors at the time of interaction of the vehicle occupant or the vehicle computing unit C1, C2, C3 with the communication unit E (e.g. fuel/charge level, number of occupants, active indicator lights, etc.).

This context information, which are transmitted from the vehicle computing unit C1, C2, C3 to the communication unit E, can additionally be correlated on the server computing unit K with data from external sources, for example with:
Weather information for the respective position of the vehicle and/or the corresponding time,
Traffic information for the respective position of the vehicle and/or the corresponding time.

The server computing unit K combines/correlates individual and collaborative recommender systems into a so-called hybrid recommender system. For this purpose, several recommender algorithms are weighted or executed in series. Thus, disadvantages of individual approaches are compensated by the integration of further methods.

The individual recommendation system determines recommended offers or navigation destinations based only on information about the (active) vehicle occupant. This is done using the individual data history of the vehicle and/or vehicle occupant based on previous driver information and/or vehicle information L1, F1. In this way, for example, it can be determined which offers are always rejected in principle or accepted with a high probability.

In the collaborative recommendation system (also called “collaborative filtering”), drivers of other vehicles are also considered when making recommendations. The recommendation process for prioritizing a navigation destination (in collaborative filtering) basically consists of two steps:
1. calculating/identifying a number of vehicle occupants who have scored similarly to the active vehicle occupant in the past (neighborhood),
2. selection of navigation destinations or offers which the active vehicle occupant has not yet assessed/selected/approached, but which have been assessed as recommendable in his neighborhood.

For the neighborhood calculation in the 1st step, the ratings of the active vehicle occupant are compared with those of the other vehicle occupants in the system.

The result hybrid recommender system is a priority value.

In one embodiment, the provider of offer O1 is an operator of a restaurant and the provider of offer O2 is an operator of a snack bar.

The provider of offer O1, for example, knows that from experience only very rarely or never single persons come to his restaurant and therefore stores corresponding offer parameters on the offer server S that he specifically wants to address vehicles with more than one vehicle occupant.

For example, the provider of offer O2 knows that from experience very often single persons come to his snack bar for a quick meal and therefore stores appropriate offer parameters on the offer server S that he would like to specifically address vehicles with one (single) vehicle occupant.

The number of vehicle occupants can be detected on the vehicle side using corresponding vehicle sensors, such as force sensors in the vehicle seats. The detected sensor signals of the vehicle sensors are transmitted to the communication unit E by means of the respective vehicle computing unit C1, C2, C3 with the respective navigation requests N1, N2, N3.

Vehicle computing unit C3 detects, for example, via corresponding vehicle sensors, that there are several—for example, four—persons in the vehicle. The navigation request N3 contains a piece of driver information that an opportunity to eat something is being sought and a piece of vehicle information that there are four vehicle occupants in the corresponding vehicle.

Vehicle computing unit C2 detects, for example, via corresponding vehicle sensors, that there is a (single) person in the vehicle. The navigation request N2 includes a piece of driver information that a possibility to eat something is being sought and a piece of vehicle information that there is a (single) vehicle occupant in the corresponding vehicle.

Vehicle computing unit C2 now receives the offer location of the snack bar according to offer O2 as a prioritized navigation destination (top entry of the shown list) in response to navigation request N2.

Vehicle computing unit C3 now receives the offer location of the restaurant according to offer O1 as a prioritized navigation destination (top entry in the list shown) in response to navigation request N3.

According to this embodiment, the prioritized navigation destination is thus essentially determined by the number of vehicle occupants according to the offer parameters stored on the offer server S.

Alternatively or additionally, the providers of the offers O1, O2, O3 can also store further offer parameters—for example, that they want to address special vehicle models or groups of people. Likewise, further driver information and/or vehicle information can be considered when prioritizing navigation destinations.

In an extension of the invention, the offer parameters may include, for example, additional information about further goods or services at the offer location, for example, that (in addition to the goods or services) one or more charging stations are available (at the offer location or in the vicinity of the offer location) and/or that a benefit is received when the goods or services are purchased. Such a benefit may be, for example, free or discounted vehicle battery charging or a free cup of coffee.

Further signal values from vehicle sensors can be considered for prioritizing the navigation destinations. For example, a filling level sensor determines the filling level of a tank or a battery of the vehicle with vehicle computing unit C1 and transmits this with the navigation request N1.

This is described in more detail below in connection with the embodiment according to FIG. 2.

In the embodiment according to FIG. 2, the driver indicates, for example, that he wants to take a coffee break. At the same time, a filling level sensor of the vehicle detects that the battery charge level of the vehicle is low and that charging of the battery is necessary or will soon become necessary. Thus, in this example, the piece of driver information L1 comprises the need for an offer of coffee. The piece of vehicle information F1 comprises a piece of information that a battery charge of the vehicle is necessary or will soon become necessary. This information is transmitted with the navigation request N1 from the vehicle computing unit C1 to the communication unit E (not shown in FIG. 2).

Although the offers or the corresponding offer locations O1 and O2 are closer than the offer O3, in this embodiment the driver receives the prioritized navigation destination according to offer O3, because the provider for offer O3 has stored on the offer server S (not shown here) that a charging station is available at the offer location (or in its vicinity) according to offer O3.

In a (further) embodiment, the system is equipped with transaction recognition.

If the driver actually drives to the offer O3 and/or makes a transaction there (for example, buying a cup of coffee and/or charging the vehicle), this information is transmitted from the vehicle computing unit C1 to the communication unit E as result information.

Whereby the result information comprises a (GPS) position of the vehicle (at or near the offer location) determined by means of the position sensor. The result information is transmitted, for example, by the vehicle computing unit C1 as soon as the vehicle is parked and/or the engine is switched off.

Alternatively or additionally, a localization zone (geofence) may be provided around an offer location. In this way, result information comprising a position of the vehicle can be transmitted as soon as the vehicle is detected in the localization zone by means of the position sensor of the vehicle.

In this way, it can be acquired that the vehicle has (actually) approached an offer location.

In a further development, a piece of result information can be sent again as soon as the vehicle's engine is restarted and/or the vehicle starts moving again or leaves the localization zone (again). This can also be used to transmit a time spent at the location of the offer.

The result information may further include a piece of transaction information related to a transaction (for example, a purchase) made at the offer location.

For example, the piece of transaction information can be captured via a corresponding app on a user terminal (for example, smartphone) of the driver by interaction of the user terminal with a payment system at the point of offer.

In one embodiment, the transaction information is captured by payment with the user terminal at the payment system at the offer location.

Alternatively or additionally, the driver can use the user terminal to scan, for example, a QR code at the payment system at the offer location and then be directed to a website on his user terminal, where he completes the transaction by confirming it.

Alternatively or additionally, the driver can transmit a piece of offer verification information (for example, a QR code) to a user terminal via a vehicle interaction (for example, scanning or photographing a QR code displayed on the vehicle display). The piece of offer verification information can be verified at the payment system at the offer location, for example, scanned with a corresponding reader. In this way, the driver can also receive corresponding benefits according to the offer, if applicable.

The piece of transaction information can either be transmitted directly from the user terminal to the communication unit E or (as soon as the driver is back at/in the vehicle) be transmitted to the vehicle computing unit C2 and from there be transmitted to the communication unit E as piece of result information.

Alternatively or additionally, the result information or the transaction information can also be captured on the provider's side and transmitted to the communication unit E. For example, by the till system and/or an (independent) recognition of the user terminal via WLAN or Bluetooth signals of the user terminal when entering or leaving the offer location. In a further embodiment, a facial recognition of the driver can also be determined when entering or leaving the offer location.

By a corresponding positive or negative result with respect to an offer or a prioritized navigation destination, the driver information and/or vehicle information can be updated accordingly. Subsequent navigation requests can be optimized considering this (piece of) result information—for example, by means of a self-learning system of the server computing unit K—for example, a neural network. The self-learning system can generate corresponding driver profiles based on a plurality of driver information and vehicle information as well as result information, and thus further optimize future navigation destinations with respect to future navigation requests for drivers according to the respective driver profile. On the one hand, the selection of offers or the assignment of a priority value can be improved in this way. In addition, it is possible to create feedback for providers of the offers—in this way, a provider can optimize the offer parameters.

Of course, the above example is not limited to electric cars with corresponding batteries. Accordingly, this example can of course be transferred to vehicles with combustion engines or hybrid engines and refueling instead of charging.

In an alternative embodiment, the filling level sensor detects an (almost) empty battery and/or tank and, based on the sensor signals from the filling level sensor (without further action by the driver), sends the navigation request N1 to the communication unit E. In response to the navigation request N1, the driver then receives a prioritized navigation destination in accordance with offer O3, since a fuel pump or charging station is available there. For example, the driver may also be offered/indicated that he can obtain a discounted charge in accordance with offer O3 if he buys a coffee.

Furthermore, an extension of the invention likewise includes that an autonomously driving vehicle autonomously navigates to the offer location according to offer O3 when a navigation to the prioritized navigation destination is initialized in response to the navigation request N1.

FIG. 3 shows an alternative embodiment of the present invention.

The vehicle computing unit C2 detects and recognizes an object E1 in the vehicle surrounding (for example, at the roadside) with an optical sensor. According to the embodiment, the vehicle computing unit C2 detects, for example, an advertising poster for a nearby attraction—for example, a zoo. At the same time, the vehicle computing unit C2 uses force sensors in the seats of the vehicle to detect four occupants—for example, a family. The vehicle computing unit C2 transmits a navigation request N2 in response to a detection of an object E1 by an optical sensor of the vehicle in the vehicle surrounding to the communication unit E (not shown), transmitting the piece of vehicle information F2 with the navigation request N2 related to the occupants and/or that the vehicle is a family vehicle (for example, minivan).

On the offer server S (not shown here), an offer O2 is stored for which the object E1 advertises. The object E1 can be, for example, a poster with a corresponding machine-readable coding.

In this regard, the offer O2 comprises at least one offer parameter that contains information that the offer O2 is directed at families and/or is directed at drivers of family vehicles.

In response to the navigation request N2, the driver receives offer O2 as a prioritized navigation destination from the computing unit and, as appropriate, displays it graphically and can initialize navigation to the offer location of offer O2.

If the driver actually drives to the offer O2 and stays longer at the offer location, this piece of information (for example, parking time 4 hours) is transmitted to the communication unit E as piece of result information.

With a corresponding positive or negative result, the driver information and/or vehicle information can be updated accordingly. Subsequent navigation requests can be optimized considering this (piece of) result information. On the one hand, the selection of offers or the assignment of a priority value can be improved in this way. In addition, it is possible to create feedback for providers of the offers—in this way, a provider can optimize the offer parameters.

Alternatively, if the vehicle computing unit C2 had transmitted, for example, the piece of vehicle information F2 that there was only a single occupant in the vehicle and/or that the vehicle was a sports car (and not a family vehicle), the offer O2 directed at families would have tended not to be displayed/suggested to the driver in response to the detection of the object E1 because a low priority value would have been determined.

FIG. 4 shows another embodiment of the present invention.

In the embodiment according to FIG. 4, an autonomously driving (driverless) vehicle with a vehicle computing unit C1 is shown.

In this embodiment, there is no driver or vehicle occupant in the vehicle. For example, the vehicle occupant or occupants have left the vehicle at an offer location. In this embodiment, the vehicle is to be autonomously moved to a parking position.

According to the embodiment, the vehicle computing unit C1 may transmit a navigation request N1 to the communication unit E (not shown). The navigation request N1 comprises the piece of vehicle information F1 indicating that a parking space P is sought/needed for the vehicle.

Various parking lot providers or parking garage providers have stored their respective (parking lot) offers O1, O2 and O3 on the offer server S (not shown). The offers O1, O2, O3 comprise offer parameters that include a parking space capacity at the respective offer location (parking lot or parking garage).

In the embodiment according to FIG. 4, the parking garage according to offer O3 is transmitted to the vehicle computing unit C1 as the prioritized navigation destination, since parking spaces are available at the offer location according to offer O3.

Based on the prioritized navigation destination, the vehicle computing unit C1 may initialize a navigation to the corresponding offer location according to offer O3 to park the vehicle there.

In an extension of the invention, the vehicle computing unit C1 may transmit a piece of reservation information to the communication unit E so that, based on this, at least one parking space P at the corresponding offer location is kept free until the vehicle arrives. In this way, an autonomous search for a parking space can be carried out efficiently and simply.

Alternatively or additionally, the offer parameters may include parking fees or corresponding distances from the offer location, such that a parking lot availability, a distance, and parking fees are each weighed to prioritize the navigation destination.

In an extension of the invention, providers may also store dynamic offer parameters for a corresponding offer on the offer server S.

Whereby a dynamic offer parameter means that it changes depending on at least one variable (to be defined by the prover).

In the embodiment according to FIG. 4, a dynamic offer parameter may comprise, for example, a (dynamic) parking fee that varies depending on a time of day or a season of the year or with a number of available (free) parking spaces.

For example, underutilized parking lots can thus reduce their parking fees to incentivize that offer location according to offer O3 would (also) be approached (prioritized), even if offer location according to offer O2 would also have free parking spaces.

FIG. 5 shows another embodiment of the present invention.

In the embodiment according to FIG. 5, a vehicle, preferably driving autonomously, with a vehicle computing unit C1 is shown. In this embodiment, the vehicle is, for example, a vehicle of a vehicle fleet of a car sharing provider or a passenger transport service provider.

A user of the car sharing provider or the passenger transport service provider can rent the vehicle. According to this embodiment, there is a vehicle occupant in the, preferably autonomously driving, vehicle.

In this embodiment, two restaurant operators have each stored a corresponding offer O1, O2 for their restaurant on the offer server S (not shown).

Offer O1 includes an offer parameter that specifies that for users or vehicle occupants of a vehicle of a car sharing provider or a passenger transport service provider, the travel costs (rent for the vehicle or route costs) for a meal in the restaurant according to offer O1 are reimbursed or covered. Offer O1 thus comprises an offer parameter that is directed towards a free journey to the offer location—for example for vehicles within a radius of 5 km or 10 km or 50 km around the offer location. According to the invention, further offer parameters can be defined for this purpose.

A user or vehicle occupant of the vehicle sends a navigation request N1 with the vehicle computing unit C1 to the (not shown) communication unit E. In this embodiment, the navigation request N1 includes a piece of driver information L1 that a possibility to eat something is being searched for.

Under certain circumstances, further driver information and/or vehicle information can be transmitted and taken into account—for this, explicit reference is made to the preceding embodiments.

In response to the navigation request N1, the restaurant according to offer O1 is displayed to the vehicle occupant as a prioritized navigation destination. Alternatively or additionally, a navigation to the offer location according to offer O1 can be initialized directly.

It should be noted at this point that all of the parts described above are claimed to be essential to the invention when considered alone and in any combination, especially of the details shown in the drawings.

### LIST OF REFERENCE SIGNS

E communication unit

N1, N2, N3 navigation requests

C1, C2, C3 vehicle computing units

F1, F2 piece of vehicle information

L1 piece of driver information

S offer server

O1, O2, O3 offers

K (server) computing unit

E1 object

1. A system for prioritizing navigation destinations of vehicles, comprising:
a communication unit adapted to receive at least one navigation request from at least one vehicle computing unit, the at least one navigation request being assigned at least one piece of vehicle information and/or piece of driver information;
an offer server on which a plurality of offers are stored, wherein a plurality of offer parameters, comprising an offer location, are associated with each offer; and
a server computing unit adapted to,
a) determining a selection of offers based on the navigation request;
b) assigning a priority value to the offers of the selection of offers, considering the offer parameters and at least one piece of vehicle information and/or piece of driver information of the navigation request; and
c) sending the assigned priority values to the at least one vehicle computing unit in response to the navigation request to cause the at least one vehicle computing unit to prioritize at least one navigation destination using the priority value.

2. The system for prioritizing navigation destinations of vehicles according to claim 1,
wherein the communication unit is further adapted to receive result information from the at least one vehicle computing unit, the result information comprising information indicating whether a corresponding vehicle has approached an offer location of a corresponding offer, and/or indicating corresponding stay times at the offer location, and/or indicating whether a transaction has been made at the offer destination.

3. The system for prioritizing navigation destinations of vehicles according to claim 1, further comprising: vehicles each having at least one vehicle computing unit.

4. The system for prioritizing navigation destinations of vehicles according to claim 2, wherein the at least one vehicle computing unit is adapted to acquire and/or evaluate sensor signals from vehicle sensors and to determine the result information based on the sensor signals, and to transmit the result information to the communication unit.

5. the system for prioritizing navigation destinations of vehicles according to claim 1,
wherein the vehicle comprises vehicle sensors, for example position sensors, filling level sensors, force sensors, and the at least one vehicle computing unit is adapted to transmit the vehicle information and/or the driver information at least partially using sensor signals from at least one of the vehicle sensors.

6. The system for prioritizing navigation destinations of vehicles according to claim 1,
wherein the server computing unit and/or the at least one vehicle computing unit is/are adapted to filter the plurality of offers according to the respective priority value such that only offers and/or priority values above a priority value limit are considered when sending to the vehicle computing unit.

7. The system for prioritizing navigation destinations of vehicles according to claim 1,
wherein the at least one vehicle computing unit is adapted to transmit a piece of offer verification information to a user terminal such that a transaction at the offer location can be verified outside the vehicle by a provider.

8. The system for prioritizing navigation destinations of vehicles according to claim 1,
wherein the vehicle computing unit is adapted to cause a vehicle interaction device to display at least one prioritized navigation destination.

9. The system for prioritizing navigation destinations of vehicles according to claim 1,
wherein the at least one vehicle computing unit is adapted to acquire and/or evaluate sensor signals from vehicle sensors, and to send at least one navigation request to the communication unit based on the sensor signals.

10. The system for prioritizing navigation destinations of vehicles according to claim 9,
wherein the vehicle computing unit is adapted to detect passenger fatigue and/or to detect a tank condition or charge state and/or to detect an object in the surrounding of the vehicle and/or to detect a stimulus word in the passenger compartment, based on the sensor signals of at least one of the vehicle sensors.

11. A method for prioritizing navigation destinations of vehicles, comprising:
receiving at least one navigation request from at least one vehicle computing unit of a vehicle, wherein at least one piece of vehicle information and/or piece of driver information is assigned to the at least one navigation request, by means of a communication unit;
providing a plurality of offers on an offer server (S), wherein a plurality of offer parameters, comprising an offer location, are associated with each offer;
determining a selection of offers based on the at least one navigation request;
assigning priority values to the offers of the selection of offers, considering the offer parameters and at least one piece of vehicle information and/or piece of driver information of the navigation request;
sending the assigned priority values in response to the navigation request to the at least one vehicle computing unit; and
prioritizing a navigation destination using the priority values.

12. The method for prioritizing navigation destinations of vehicles according to claim 11, further comprising:
receiving result information from the at least one vehicle computing unit with the communication unit, wherein the result information comprises information indicating whether a corresponding vehicle has approached an offer location of a corresponding offer, and/or indicating corresponding stay times at the offer location, and/or indicating whether a transaction has been made at the offer destination.

13. The method for prioritizing navigation destinations of vehicles according to claim 11,
wherein the at least one navigation request is sent in response to a passenger fatigue, detected by a fatigue sensor, and/or an acoustic signal or signal sequence, detected by an acoustic sensor.

14. The method of prioritizing navigation destinations of vehicles according to claim 11,
wherein the at least one navigation request is sent in response to a detection of an object by an optical sensor in the vehicle surrounding.

15. The method of prioritizing navigation destinations of a vehicle according to claim 11,
wherein the at least one navigation request is sent in response to a low battery charge state and/or low tank filling state detected by a filling level sensor.

16. A computer-readable storage medium comprising instructions that, when executed by at least one computing unit, cause the computing unit to implement a method according to claim 11.

17. The system according to claim 1, wherein the at least one vehicle computing unit is adapted to transmit a piece of offer verification information to a user terminal such that a transaction at a checkout at the offer location can be verified outside the vehicle by a provider.

18. The system according to claim 8, wherein the vehicle computing unit is further adapted to cause the vehicle interaction device to display a piece of offer information, such that the at least one prioritized navigation destination is selectable by means of the vehicle interaction device to initialize a navigation to a prioritized navigation destination.

19. The system according to claim 9, wherein the vehicle sensors include at least one of an acoustic sensor, an optical sensor, a fatigue sensor, a filling level sensor, or a combination thereof.

20. The method according to claim 13, wherein the at least one navigation request sent in response to a passenger fatigue includes a stimulus word in the passenger compartment.
